(19) United States
(12) Patent Application Publication
(10) Pub. No.: US 2013/0017781 A1
(43) Pub. Date: Jan. 17, 2013

(54) COMMUNICATION APPARATUS

(71) Applicant: Steve Jones, Kents Hill (GB)

(72) Inventor: Steve Jones, Kents Hill (GB)

(73) Assignee: Cambridge Silicon Radio Limited, Cambridge (GB)

(21) Appl. No.: 13/545,642

(22) Filed: Jul. 10, 2012

(30) Foreign Application Priority Data
Jul. 11, 2011 (GB) 1111841.1

(51) Int. Cl. H04B 5/02; H04B 1/44

(52) U.S. Cl. 455/41.1; 455/90.3; 455/78

(57) ABSTRACT

A communication apparatus (10) has an antenna (12) suitable for transmitting and receiving signals in a near-field communication (NFC) frequency band. A resonant network is connected to the antenna (12), which is configured to adjust a self resonant frequency of the antenna (12) such that a signal in an FM frequency band may be transmitted or received by the antenna (12). An integrated circuit may be provided with the communication apparatus (10).

### CROSS-REFERENCE TO RELATED APPLICATIONS

The present application claims priority from Great Britain Patent Application No 1111841.1 filed on 11 Jul. 2011, entitiled “COMMUNINCATION APPARATUS”, the contents of which are incorporated herein by reference.

### TECHNICAL FIELD

The present invention relates to communication of data and, more particularly, to wireless communication of frequency modulated (FM) signals using a near field communication (NFC) antenna.

### BACKGROUND OF THE INVENTION

Mobile communication devices, such as mobile telephones, smart phones, personal digital assistants (PDA) and laptop computers are often provided with means for communicating wirelessly with other such devices, and with other communication devices.

One such means of communicating wirelessly uses near field communication (NFC). Near field communication is the name given to the communication of data over a distance of less than around 5 cm. NFC operates at a frequency of 13.56 MHz, and allows data to be transferred at rates from 106 kbit/s to 848 kbit/s. Data is transmitted between an NFC initiator and an NFC target. The initiator (often referred to as a reader) is a powered device that emits a radio frequency (RF) field. The target need not be powered, and typically takes the form of a key fob, a card or a mobile telephone. When an NFC target is moved into the RF field emitted by the initiator, the target is powered by the RF field, and emits a signal which is detected by the initiator.

An example of how NFC technology is used is in a security system for securing access to a restricted area or building. An NFC initiator is installed in a unit positioned near to, say, a restricted entrance or door. The initiator emits a radio frequency (RF) field. When a target, which may take the form of a key card or a key fob, is moved into the RF field emitted by the initiator, the target, which is powered by the RF field, emits a signal which is detected by the initiator unit. If the security system recognises the returned signal as one from a card authorised to access the entrance or door, then it sends a signal to another part of the security system to grant access to the restricted area, for example by unlocking the door or deactivating an alarm system.

Frequency modulation (FM) is a well known method of modulating a signal onto a carrier. An example of how frequency modulation is used is in broadcasting FM radio signals. While it is possible to transmit an FM radio broadcast on any frequency, in most of the world, the FM frequency band ranges from 87.5 to 108.0 MHz. The distance over which an FM radio broadcast is emitted via a radio antenna depends, amongst other things, on the power output of the broadcast antenna.

The transmitted radio waves are received by a second antenna located in a receiving device such as, for example, a portable radio or a vehicle radio. It is also known to install FM demodulation equipment in mobile communication devices, such as mobile telephones, smart phones and laptop computers. For receiving FM signals via a mobile telephone, it is known to use a headphone cable as an antenna. Typically, a user is only able to listen to an FM radio broadcast through his or her mobile telephone while the headphones are plugged in. It is not common for mobile telephones to be provided with means for transmitting FM signals. One reason for this is that a separate antenna to be used solely for transmitting FM signals would need to be installed in the telephone. Due to the limited space available in mobile telephones, it is undesirable to install a separate antenna in a mobile telephone.

Due to the difference in frequencies at which NFC and FM communication operates, each requires an individual antenna. It is uncommon for devices to include antennas for both NFC and FM communication, because space inside devices is generally limited.

### SUMMARY

According to a first aspect of the present invention, a communication apparatus comprises an antenna configured to transmit and receive signals in a near-field communication (NFC) frequency band, and a resonant network connected to the antenna at a point intermediate ends of the antenna, such that the apparatus is able to use the antenna to transmit or receive a signal in an FM frequency band. By connecting the resonant network to the antenna at particular points intermediate ends of the antenna, the effective length of the antenna used by the resonant network is shorter than the total length of the antenna used when transmitting and receiving signals in an NFC frequency band. An advantage of using a single antenna for transmitting and receiving signals in both a near-field communication frequency band in an FM radio frequency band is that fewer components are required, resulting in less space being required, and lower costs. For example, an NFC antenna installed in a mobile telephone handset can be used for FM communication also. Thus, a second antenna is not required.

The resonant network may be connected to the antenna at its common mode point. Alternatively, the resonant network may be connected to the antenna at points equidistant from the common mode point of the antenna. Preferably, the resonant network is connected to the antenna at points midway between the common mode point and the ends of the antenna. By connecting the resonant network to the antenna at the common mode point, or at points equidistant from the common mode point, the antenna is effectively shortened, and the self-resonant frequency of the antenna is adjusted such that it is suitable for transmitting and receiving signals in an FM radio frequency band.

Advantageously, the self-resonant frequency of the portion of the antenna used to receive or transmit a signal in an FM frequency band is greater than the self-resonant frequency of the portion of the antenna used to receive or transmit a signal in a near-field communication frequency band.

Preferably, when the antenna is used for transmitting and/or receiving signals in a near-field communication (NFC) frequency band, the antenna has a self-resonant frequency (SRF) of between 40 MHz and 60 MHz and, more preferably of around 50 MHz. This range of frequencies is advantageous for the self-resonant frequency of the antenna as it is above the frequency at which NFC signals are transmitted and received.

Preferably, when the antenna is used for transmitting and/or receiving signals in a frequency modulated (FM) radio frequency band, the antenna has a self-resonant frequency (SRF) of between 150 MHz and 170 MHz and, more preferably of around 160 MHz. This range of frequencies is advantageous for the self-resonant frequency of the antenna as it is above the frequency at which FM signals are transmitted and received.

Advantageously, when the antenna is used for transmitting signals in a frequency modulated (FM) radio frequency band, the resonant network is arranged to exhibit series resonance, and when the antenna is used for receiving signals in a frequency modulated (FM) radio frequency band, the resonant network is arranged to exhibit parallel resonance.

Series resonance occurs at the frequency at which the input impedance of a resistor, inductor and capacitor circuit falls to a minimum. Parallel resonance occurs at the frequency at which the input impedance of a resistor, inductor and capacitor rises to a maximum. It is possible for a circuit having a particular combination of resistor, inductor and capacitor to exhibit both series resonance and parallel resonance. However, the series resonance and parallel resonance will occur at different frequencies. By rearranging the connections of the resistor, inductor and capacitor components by using switches, it is possible to switch from series resonance to parallel resonance at the same frequency.

The resonant network may comprise one or more capacitors, one or more of which are capable of being used to tune the frequency at which signals can be transmitted and received in the FM frequency band. Alternatively, the resonant network may comprise one or more switches for allowing a selection to be made between transmitting and receiving signals in a frequency modulated (FM) radio frequency band. The antenna cannot be used for transmitting and receiving signals in an FM radio frequency band at the same time. Therefore, by tuning the capacitors, or by using switches, the resonant network may be switched between a transmitting mode, in which signals may be transmitted, and a receiving mode, in which signals may be received. The switching may be done electronically, and may be done automatically, when a received signal or a signal for transmission is detected, or manually by a user.

Preferably, the resonant network is connected to the antenna in a single-ended mode, and the signals in an NFC frequency band are transmitted and received via a differential input/output.

According to a second aspect of the present invention, a communication apparatus comprises an antenna; a first transmitter/receiver for transmitting and receiving signals, said first transmitter/receiver being connected to the antenna in a differential mode; and a second transmitter/receiver for transmitting and receiving signals, said second transmitter/receiver being connected to the antenna in a single-ended mode. By connecting the first and second transmitters/receivers to the same antenna, in differential and single-ended modes respectively, there is increased isolation between the two transmitters/receivers. This results in less interference between NFC and FM signals. Furthermore, the increased isolation means fewer components are required to achieve a satisfactory level of isolation.

The first transmitter/receiver may be arranged to transmit and receive signals in a near-field communication (NFC) frequency band, and the second transmitter/receiver may be arranged to transmit and receive signals in an FM frequency band.

Preferably, the second transmitter/receiver is connected to the antenna at its common mode point, and is a resonant network.

According to a third aspect of the present invention, an integrated circuit comprises the apparatus described above.

### BRIEF DESCRIPTION OF THE DRAWINGS

Various embodiments of the invention will now be described, by way of example only, with reference to the accompanying drawings, in which:

FIG. 1 is a schematic drawing of an antenna for use in NFC and FM communication;

FIG. 2 is a schematic drawing of the antenna of FIG. 1, shown in an alternative configuration;

FIG. 3 is a circuit diagram showing an antenna having a differential NFC input/output terminal and a differential FM transmit output;

FIG. 4 is circuit diagram showing an antenna having a differential NFC input/output terminal and a differential FM receive input;

FIG. 5 is a schematic drawing of an antenna having a single-ended NFC input/output terminal and a single-ended FM transmit output;

FIG. 6 is a schematic drawing of an antenna having a single-ended NFC input/output terminal and a single-ended FM receive input;

FIG. 7 is a circuit diagram showing an antenna having a differential NFC input/output terminal and a single-ended FM transmit output; and

FIG. 8 is a circuit diagram showing an antenna having a differential NFC input/output terminal and a single-ended FM receive input.

### DETAILED DESCRIPTION

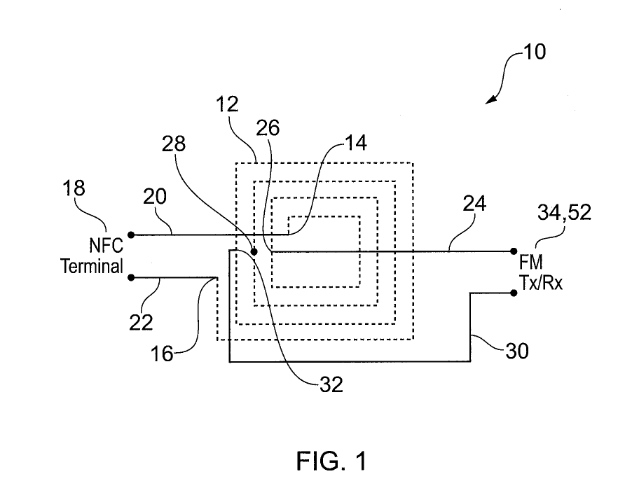

Referring to the drawings, FIG. 1 shows, schematically, an antenna arrangement 10 having an antenna 12 which is formed from a plurality of coil turns. In the drawings of this specification, the antenna 12 is shown to have four turns. However, one skilled in the field of antenna design will appreciate that the antenna 12 may be formed from a coil having any number of turns.

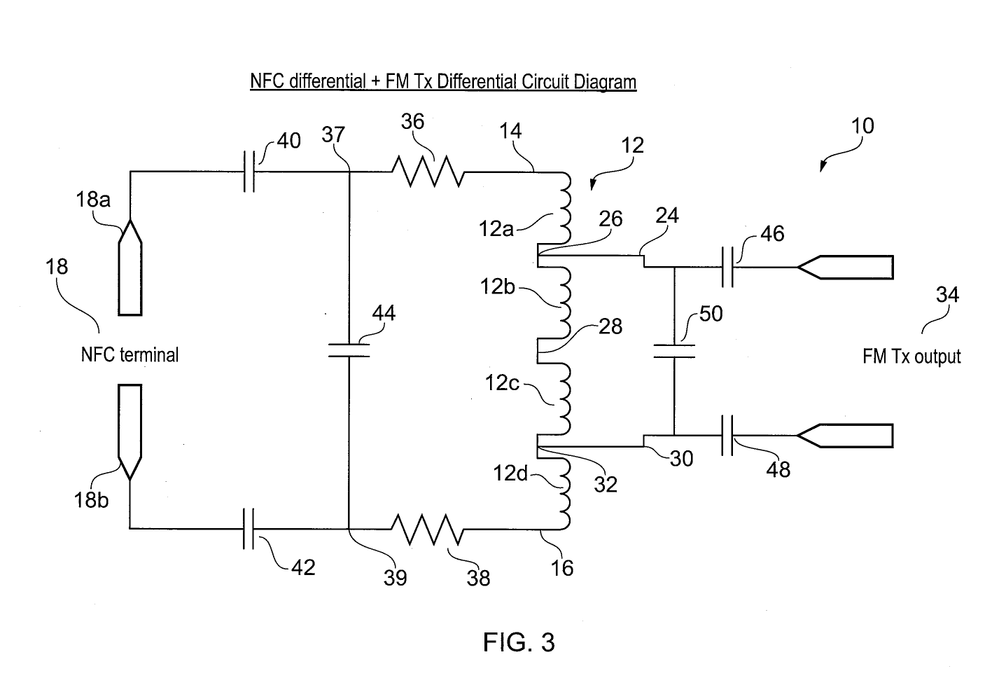

The antenna 12 has a first end 14 and a second end 16. The ends 14, 16 of the antenna 12 are connected to circuitry (as explained below with reference to FIGS. 3 to 8) and to an NFC input/output terminal 18 via connectors 20 and 22. A connector 24 is connected to the antenna 12 at a point 26, which is one coil turn from the first end 14 of the antenna. The point 26 is the midway point between a common mode point 28 of the antenna 12 and the end 14 of the antenna. In other words, the point 26 is a quarter of the way along the coil from the end 14 of the antenna 12. A connector 30 is connected to the antenna 12 at a point 32 which is one coil turn from the second end 16 of the antenna. The point 32 is the midway point between the common mode point 28 of the antenna 12 and the end 16 of the antenna. In other words, the point 32 is three-quarters of way along the coil from the end 14 of the antenna 12, or a quarter of the way along the coil from the end 16 of the antenna. The connectors 24 and 30 are connected to circuitry (as explained below with reference to FIGS. 3 to 8) and to an FM transceiver 34.

The term “common mode point”, used to denote the point 28 is intended to mean the point between the ends 14, 16 of the antenna 12, where the differential signal across the antenna is split 50:50. At this point, no signal is present with respect to ground (since the positive and negative input signals alternate either side of ground), so it appears as a ground connection. The differential input signal at the common mode point 28 (in other words, the electrical centre) of the antenna 12 should be minimized. This, in turn, minimizes interference from the differential input signals into any apparatus connected to the antenna at the common mode point. The connections to the FM transceiver are ‘tapped in’ to the antenna at points where the antenna is balanced. That way, any interference between transmitted and received NFC signals and FM signals is minimised to a level at which the effect of the interference is negligible. It will be appreciated by one skilled in the art that the common mode point is not necessarily at the physical centre of the antenna coil 12. Alternatively, the common mode point might coincide with the physical centre of the antenna coil 12.

The term “NFC input/output terminal” will be understood to refer to a terminal suitable for transmitting NFC signals as well as receiving NFC signals. Hereinafter, this feature will be referred to as an “NFC terminal”.

The term “FM transmit output” refers to the output terminal into which a signal for FM transmission can be fed. The term “FM receive input” refers to the input terminal into which a transmitted FM signal is received.

The connectors 24 and 30 are connected to points 26, 32 on the antenna 12 that are midway between the common mode point 28 and the ends of the antenna coil. As noted above, in this embodiment, in which the antenna coil has four turns, the connectors 24 and 30 are connected to points 26 and 32 respectively, which are one coil turn from the respective ends 14 and 16 of the antenna 12. A person skilled in the field of antenna design will appreciate that, in an antenna having a greater number of turns, the number of coil turns between the points 26, 32 of connection and the ends 14, 16 of the antenna coil will be greater. Preferably, therefore, the antenna coil will be constructed with an even number of turns, so that the connectors 24, 30 to the FM transmission/receiving means 34 can be made at the desired points in the antenna 12; i.e. at points midway between the ends 14, 16 of the antenna 12 and the common mode point 28.

By tapping the FM transmission/receiving means 34 into the antenna 12 at suitable points as described above, the antenna, which is intended for use in near field communication, can also be used for receiving and/or transmitting FM signals.

It will be appreciated that the circuitry (not shown) referred to above enables the dual use of the antenna 12 for both near field communication and FM communication, and this circuitry will be discussed in detail with reference to FIGS. 3 to 12.

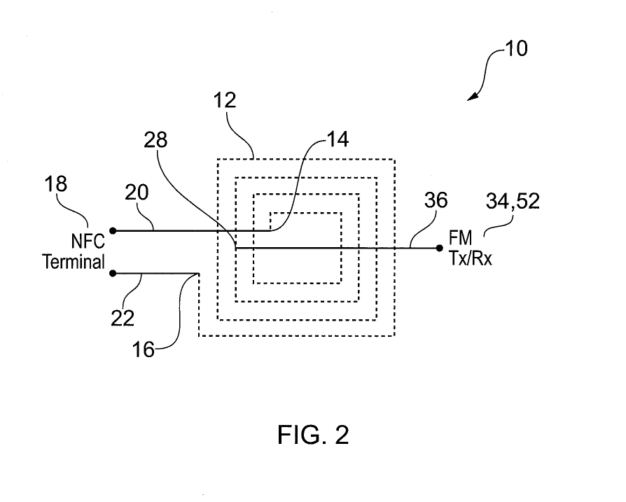

FIG. 2 shows the antenna 12 with the NFC terminal 18 and the FM transmission/receiving means 34 connected to the antenna in an alternative configuration. The connectors 20 and 22, which provide a connection between the NFC terminal 18 and the antenna 12 are connected to the ends 14 and 16 of the antenna 12 respectively. These connections are the same as those shown in FIG. 1. However, in this alternative configuration, the FM transmission/receiving means 34 is connected to the antenna 12 via a single connector 36. The connector 36 is connected to the common mode point 28 of the antenna 12. In this embodiment, in which the antenna 12 is formed of four turns, the common mode point 28 is at a point two turns from each end 14, 16 of the antenna.

In all of the embodiments of the invention discussed herein, the antenna described is a standard four-turn-coil antenna, suitable for near field communication. The antenna 12 is formed of an inductor having an inductance of 2.4 μH. The inductor has a self resonant frequency (SRF) of approximately 50 MHz, which is below the frequency band of FM signals, which is around 87.5 to 108.8 MHz. Therefore, without additional circuitry, the antenna 12 acts as a poor FM antenna.

So far, little has been said about the form of the NFC terminal 18 and the FM transmission/receiving means 34. The NFC terminal 18 may be a differential input or a single-ended input. In one embodiment, in which the NFC terminal 18 is a differential input, the NFC terminal includes a first, positive input (FIG. 3; 18a) and a second, negative input (FIG. 3; 18b). The signal to be transmitted by the antenna 12 is defined by the difference between the signal at the positive and negative inputs 18a, 18b. In an alternative embodiment, the NFC terminal 18 is a single-ended input. In this embodiment, one of the first and second ends 18a, 18b of the NFC terminal 34 is connected to ground, and an input signal is fed into the other of the first and second ends. It will be appreciated that the FM transmission/receiving means 34 may also constitute a differential input/output or a single-ended input. Embodiments incorporating these alternatives will be discussed further below.

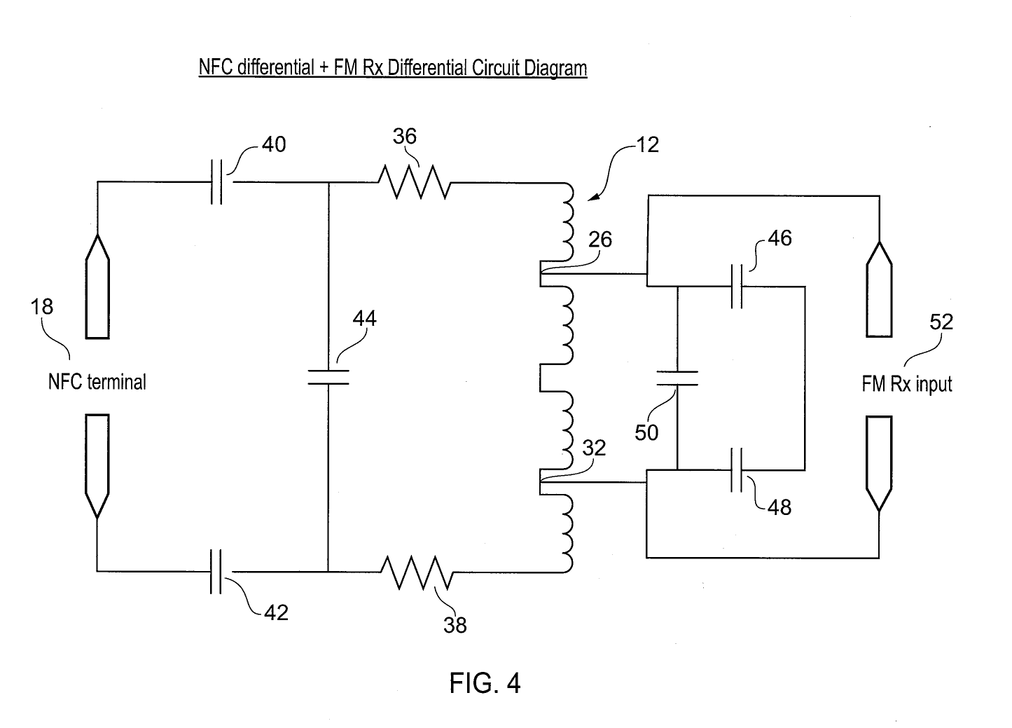

FIGS. 3 and 4 show antenna arrangements 10, each having an NFC differential input 18 consisting of a first end 18a and a second end 18b. FIG. 3 shows an embodiment having an FM transmit output 34, and FIG. 4 shows an embodiment having an FM receive input 52.

In FIG. 3, a circuit diagram showing the antenna arrangement 10 is shown. The antenna 12 is again shown in the form of four coils, 12a, 12b, 12c and 12d. The ends 14 and 16 of the antenna 12 are connected to the NFC terminal 18 via circuitry which will now be discussed in greater detail.

A resistor 36 is connected between the end 14 of the antenna 12 and a node 37. A resistor 38 is connected between the end 16 of the antenna 12 and a node 39. A capacitor 40 is connected between the node 37 and the first end 18a of the NFC terminal 18. A capacitor 42 is connected between the node 39 and the second end 18b of the NFC terminal 18. A capacitor 44 is connected between the node 37 and the node 39. The connectors 24, 30 are connected to the antenna 12 at the midway points 26, 32 between the common mode point 28 and the ends 14, 16 of the antenna. As shown in FIG. 1, the connectors 24, 30 connect the antenna 12 to the FM transmitter input 34. A capacitor 46 is connected between the point 26 of the antenna 12 and a first end 34a of the differential FM transmit output 34. A capacitor 48 is connected between the point 32 of the antenna 12 and a second end 34b of the differential FM transmit output 34. A capacitor 50 is connected in parallel with the antenna 12, between the connectors 24, 30.

By “tapping into” the antenna 12 at points 26, 32, which are equidistant from the common mode point 28 of the antenna, the antenna is effectively shortened to two coil turns. Reducing the number of turns reduces the inductance of the antenna 12 by more than a factor of four, so that the inductance per loop is 150 nH in the FM band, and the self resonant frequency is 160 MHz. At this frequency, the loop is inductive at FM frequencies. Thus, the shortened antenna 12 is suitable for use in FM communication. The arrangement of the parallel capacitor 50 and the two series capacitors 46, 48 in the arrangement shown in FIG. 3 causes series resonance and impedance transformation to occur in the circuit.

FIG. 4 shows a circuit diagram for an antenna arrangement 10 having an NFC differential input 18 and a differential FM receive input 52. The circuitry connecting the NFC terminal 18 to the antenna 12 is identical to that shown in FIG. 3. However, the FM transmit output (not shown in FIG. 4) is short-circuited, thus forming a closed loop containing the capacitors 46, 48 and 50. The FM receive input 52 is connected between the antenna 12 and a loop containing the three capacitors 46, 48, 50. The short-circuiting of the FM transmit output may be performed by a physical connection between pins on a chip in which the antenna arrangement is installed, or electronically by selectively enabling or disabling one or more of the capacitors 46, 48, 50.

With the FM transmit output 34 being short-circuited as described above, the circuit resonates at the same frequency as in the FM transmit circuit discussed in FIG. 3. In the embodiment shown in FIG. 4, however, the arrangement of the capacitors causes parallel resonance to occur in the circuit.

To enable the antenna arrangement 10 to function as both an FM receiver and an FM transmitter, the arrangement must have separate FM transmit and FM receive ports, so that one of the FM transmit or FM receive inputs can be short-circuited while the other of the inputs is active. The ports may take the form of pins of a chip in which the antenna arrangement is installed. Alternatively, the antenna arrangement 10 may have a single FM transmit/receive port. In this case, the capacitors 46, 48 are used for tuning and, consequently, for selecting whether the FM transmit/receive circuit is used for transmitting or receiving FM signals.

In one embodiment of the invention, each of the resistors 36, 38 has a resistance of 4Ω, each of the capacitors 40, 42 has a capacitance of 82 pF, the capacitor 44 has a capacitance of 10 pF, each of the capacitors 46, 48 has a capacitance of 14 pF, and the capacitor 50 has a capacitance of 6.8 pF. This particular combination of resistances and capacitances has been found to be particularly effective for enabling the antenna 12 to be used for both near field communication and FM communication with differential inputs/outputs. However, one skilled in the art will appreciate that other combinations of resistors, capacitors and other components may be used to achieve a suitable effect.

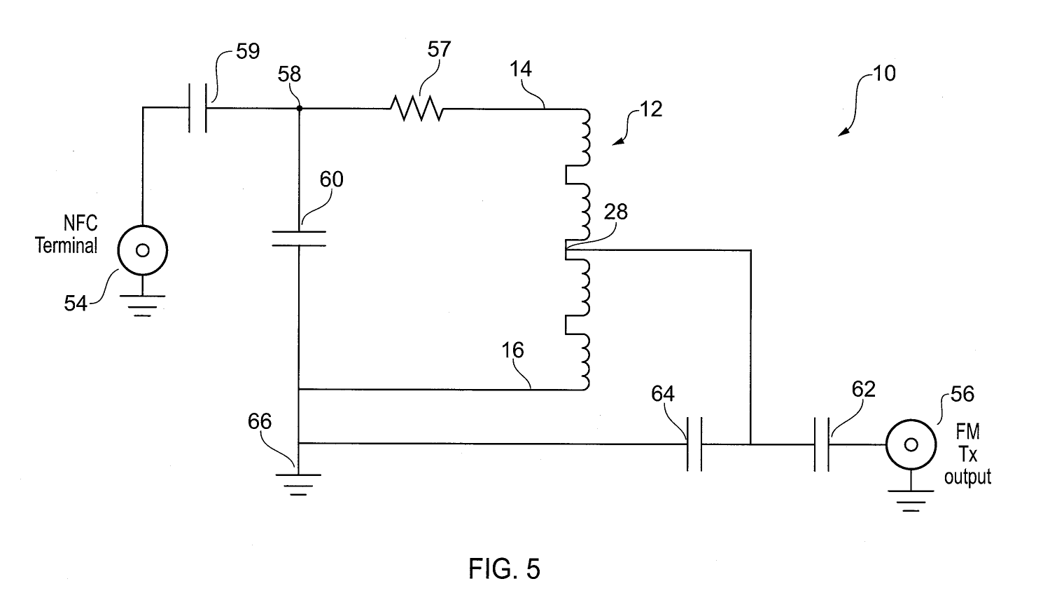

FIG. 5 shows an antenna arrangement 10 having a single-ended NFC terminal 54 and a single-ended FM transmit output 56. The end 14 of the antenna 12 is connected to the single-ended NFC terminal 54. A resistor 57 is connected in series between the end 14 of the antenna 12 and a node 58. A capacitor 59 is connected in series between the node 58 and the NFC terminal 54. A capacitor 60 is connected between the node 58 and the second end 16 of the antenna 12, and to a ground connection 66. The FM transmit output 56 is connected to the common mode point 28 of the antenna 12 via a capacitor 62. The FM transmit output 56 is also connected to the end 16 of the antenna 12 via the capacitor 62 and via a capacitor 64, and to ground via the ground connection 66.

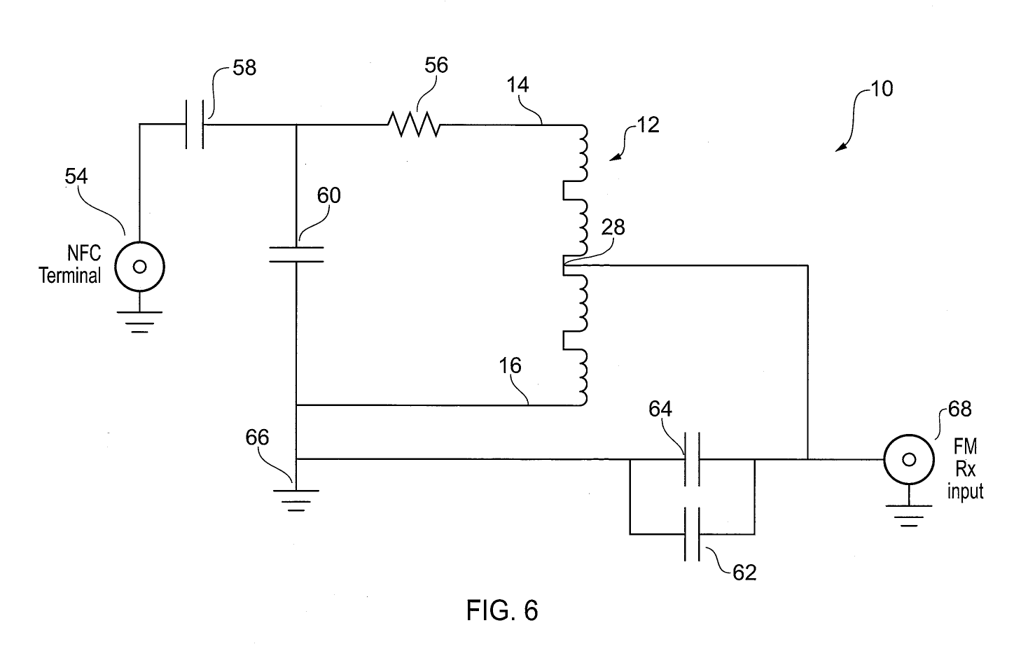

FIG. 6 shows an antenna arrangement 10 having a single-ended NFC terminal 54 and a single-ended FM receive input 68. In FIG. 6, the connections between the antenna 12 and the single-ended NFC terminal 54 via the resistor 56 and capacitors 58, 60 are identical to those shown in FIG. 5. However, in the embodiment shown in FIG. 6, the capacitor 62 is connected in parallel to the capacitor 64, so that the FM receive input 68 is connected directly to the common mode point 28 of the antenna 12.

In one embodiment of the invention, the resistor 56 has a resistance of 8Ω, the capacitor 58 has a capacitance of 39 pF, the capacitor 60 has a capacitance of 10 pF, and each of the capacitors 62, 64 has a capacitance of 6.8 pF. This particular combination of resistance and capacitances has been found to be particularly effective for enabling the antenna 12 to be used for both near field communication and FM communication with single-ended inputs/outputs. However, one skilled in the art will appreciate that other combinations of resistors, capacitors and other components may be used to achieve a suitable effect.

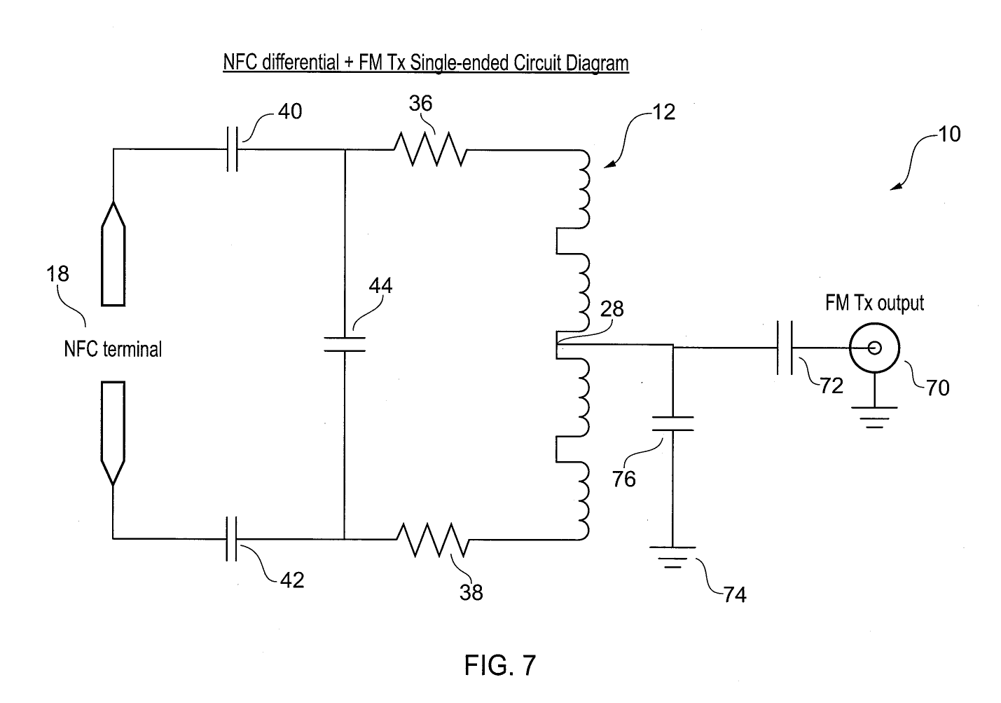

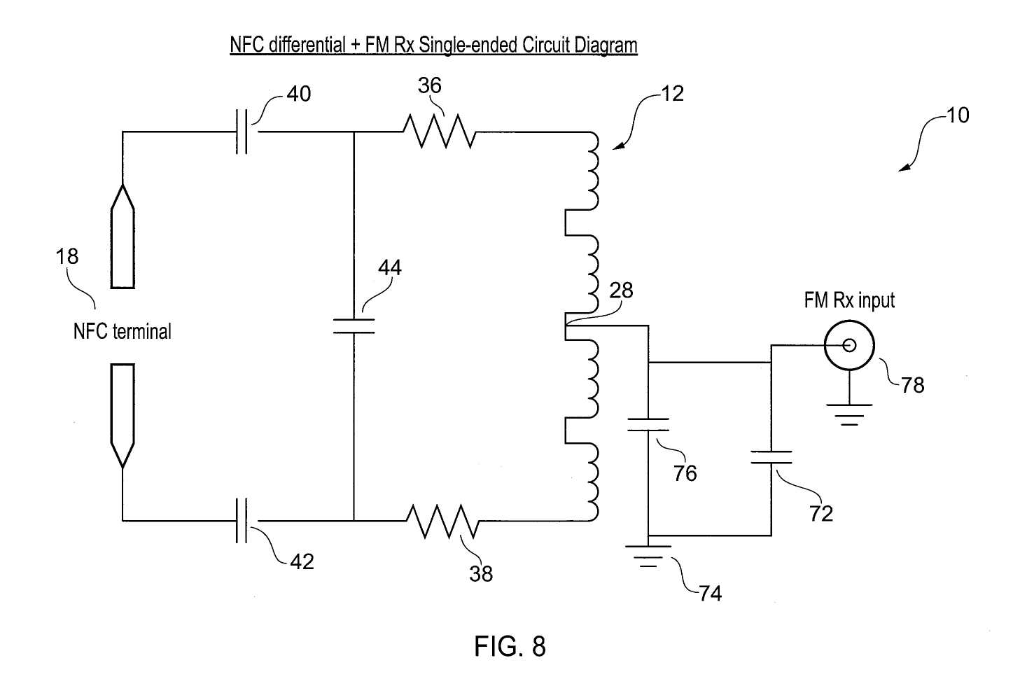

FIGS. 7 and 8 show circuit diagrams of antenna arrangements 10 each having a differential NFC terminal 18 and a single-ended FM communication connection. Referring to FIG. 7, the circuitry between the antenna 12 and the NFC terminal 18 is identical to that shown in FIG. 3. A single-ended FM transmit output 70 is connected to the common mode point 28 of the antenna 12 via a capacitor 72. The FM transmit output 70 is also connected to a ground connection 74 via a capacitor 76.

By connecting the FM transmit output 70 to the common mode point 28 of the antenna 12, the isolation of the FM transmit system from the NFC system is enhanced. Interference from the NFC system to the FM system is reduced to a negligible amount at the common mode point 28, and interference from the FM system to the NFC system appears as a common mode signal at the NFC terminal 18. In other words, interference between the NFC and FM systems is insignificant at the common mode point and, therefore, both NFC and FM signals can be transmitted and received using the single antenna.

In the embodiment shown in FIG. 8, the circuitry between the antenna 12 and the NFC terminal 18 is identical to that shown in FIG. 7. In FIG. 8, however, a single-ended FM receive input 78 is connected to the common mode point 28 of the antenna 12. The capacitor 76 is connected between the common mode point 28 of the antenna 12 and the ground connection 74. The capacitor 72 is connected in between the FM receive input 78 and the ground connection 78. In this embodiment, the arrangement of the capacitors causes parallel resonance to occur.

It will be appreciated from the embodiments described above that, for an arrangement having an FM transmit output, the selection and arrangement of the capacitors is such that the circuit is in series resonance and, for an arrangement having an FM receive input, the selection and arrangement of the capacitors is such that the circuit is in parallel resonance.

In one embodiment of the invention, each of the capacitors 72, 76 has a capacitance of 6.8 pF, each of the resistors 36, 38 has a resistance of 4Ω, each of the capacitors 40, 42 has a capacitance of 82 pF, and the capacitor 44 has a capacitance of 10 pF. This particular combination of resistance and capacitances has been found to be particularly effective for enabling the antenna 12 to be used for both near field communication and FM communication with differential NFC terminals and single-ended FM inputs/outputs. However, one skilled in the art will appreciate that other combinations of resistors, capacitors and other components may be used to achieve a suitable effect.

So far, the invention has been described in terms of individual embodiments. However, one skilled in the art will appreciate that various embodiments of the invention, or features from one or more embodiments, may be combined as required. Thus, one may combine features of the invention to obtain an antenna arrangement having a differential or single-ended NFC terminal, a differential or single-ended FM transmit output and a differential or single-ended FM receive input. A device provided with such an arrangement would be capable of transmitting a signal via near field communication, as well as transmitting and receiving frequency modulated signals. A practical use of such a combination is in a mobile telephone. A user might use a mobile telephone installed with such an antenna arrangement for making a transaction payment using the NFC part of the arrangement. At the same time, the user might listen to an FM radio station using the mobile telephone.

Some embodiments of the invention have now been described. It will be appreciated that various modifications may be made to these embodiments without departing from the scope of the invention, which is defined by the appended claims.

What is claimed is:

1. A communication apparatus comprising:
an antenna configured to transmit and receive signals in a near-field communication (NFC) frequency band; and
a resonant network connected to the antenna at a point intermediate ends of the antenna, such that the apparatus is able to use the antenna to transmit or receive a signal in an FM frequency band.

2. An apparatus according to claim 1, wherein the resonant network is connected to the antenna at its common mode point.

3. An apparatus according to claim 1, wherein the resonant network is connected to the antenna at points equidistant from the common mode point of the antenna.

4. An apparatus according to claim 3, wherein the resonant network is connected to the antenna at points midway between the common mode point and the ends of the antenna.

5. An apparatus according to claim 1, wherein the self-resonant frequency of the portion of the antenna used to receive or transmit a signal in an FM frequency band is greater than the self-resonant frequency of the portion of the antenna used to receive or transmit a signal in a near-field communication frequency band.

6. An apparatus according to claim 1, wherein, when the antenna is used for transmitting and/or receiving signals in a frequency modulated (FM) radio frequency band, the antenna has a self-resonant frequency (SRF) of greater than 150 MHz.

7. An apparatus according to claim 1, wherein, when the antenna is used for transmitting signals in a frequency modulated (FM) radio frequency band, the resonant network is arranged to exhibit series resonance.

8. An apparatus according to claim 1, wherein, when the antenna is used for receiving signals in a frequency modulated (FM) radio frequency band, the resonant network is arranged to exhibit parallel resonance.

9. An apparatus according to claim 1, wherein the resonant network comprises one or more capacitors, one or more of which is capable of being used to tune the frequency at which signals can be transmitted and received in the FM frequency band.

10. An apparatus according to claim 1, wherein the resonant network comprises one or more switches for allowing a selection to be made between transmitting and receiving signals in a frequency modulated (FM) radio frequency band.

11. An apparatus according to claim 1, wherein the resonant network is connected to the antenna in a single-ended mode.

12. An apparatus according to claim 1, wherein the signals in an NFC frequency band are transmitted and received via a differential input/output.

13. A communication apparatus comprising:
an antenna;
a first transmitter/receiver for transmitting and receiving signals, said first transmitter/receiver being connected to the antenna in a differential mode; and
a second transmitter/receiver for transmitting and receiving signals, said second transmitter/receiver being connected to the antenna in a single-ended mode.

14. A communication apparatus according to claim 13, wherein the first transmitter/receiver is arranged to transmit and receive signals in a near-field communication (NFC) frequency band.

15. A communication apparatus according to claim 13, wherein the second transmitter/receiver is arranged to transmit and receive signals in an FM frequency band.

16. A communication apparatus according to claim 13, wherein the second transmitter/receiver is connected to the antenna at its common mode point.

17. A communication apparatus according to claim 13, wherein the second transmitter/receiver is a resonant network.

18. An integrated circuit comprising the apparatus of claim 1.
